(19) United States
(12) Patent Application Publication
(10) Pub. No.: US 2025/0358130 A1
(43) Pub. Date: Nov. 20, 2025

(54) SYSTEMS AND METHODS FOR DATA QUALITY AND VALIDITY IMPROVEMENT IN EDUCATION INSTITUTIONAL, DEGREE, AND COURSE LICENSE MANAGEMENT

(71) Applicant: Woolf Inc., San Francisco, CA (US)

(72) Inventors: Joshua BROGGI, Mountain View, CA (US); Oleksii BILOUS, Kyiv (UA); Oleksii PYSANKO, Kyiv (UA); Mykhailo MARYNENKO, Stockholm (SE)

(21) Appl. No.: 19/205,306

(22) Filed: May 12, 2025

Related U.S. Application Data
(63) Continuation of application No. PCT/US2023/079507, filed on Nov. 13, 2023.
(60) Provisional application No. 63/383,634, filed on Nov. 14, 2022.

(51) Int. Cl. H04L 9/32; G06V 40/16

(52) U.S. Cl. CPC H04L 9/3239; G06V 40/172

(57) ABSTRACT

Described are platforms, systems, media, and methods for providing an accreditation management system (AMS) to validate educational resources by performing content validation operations comprising: applying a cryptographic hash function to educational resources to generate a content validation hash; receiving a data stream from a computing device of a student user engaged with the educational resources; applying the cryptographic hash function to each educational resource to generate a content consumption hash; and comparing the content validation hash to the content consumption hash.

### CROSS-REFERENCE

This application is a Continuation of International Application No. PCT/US2023/079507, filed Nov. 13, 2023, which claims the benefit of U.S. Provisional Application No. 63/383,634, filed Nov. 14, 2022, which is hereby incorporated by reference in its entirety herein.

### BACKGROUND

Learning at the tertiary level, whether conducted online or offline, typically involves online record-keeping as an increasingly popular method for data storage and retrieval. The primary (but not exhaustive) location of this record keeping is a student information system (SIS) and a learning management system (LMS). Records stored in these systems form the basis to demonstrate compliance with regulations pertaining to tertiary level education institutions.

### SUMMARY

These critical records for learning are often limited; error-prone; have limited accountability; and require substantial time to organize, maintain, and present. Such records are partial because the regulatory requirements for a tertiary level education provider to become a licensed, degree-granting institution are extensive, and there is no existing digital solution for meeting those requirements. Further, such records are error-prone because (1) to meet the record-keeping requirements of a higher education institution, evidence must be collated from diverse sources after the records were created, which introduces human judgment and error; and (2) the records themselves, including digital records, are often recorded after-the-fact and may be recorded by a third party rather than being directly created by the relevant action itself at the time of the event. For example, a student's attendance in a class is recorded by a teacher or teacher's assistant after the class has started or been completed. Additionally, current solutions lack automation, real time guarantees, and accountability and continue to function even when rules are violated because they are only inspected on an intermittent, cyclical basis (e.g., once every 5 years). Finally, existing solutions for the creation of newly accredited degree programs are not automated, whereas approval of a new degree from a Higher Education Institution may take 3-7 years.

As such, provided herein are systems, methods, and media that are comprehensive, accurate, actual, attributable, accountable, and fast. In the systems, methods, and media provided herein records may include all of the evidence from all of the domains required to meet and maintain regulatory compliance. Record keeping may maintain control of data integrity across all domains of record-keeping and data is logged in real-time to create the records. Further, records are recorded directly recorded by the relevant actors with accurate attribution, and programs either meet validation standards or validation may be revoked and they are automatically made unavailable to college staff and students.

The systems, methods, and media herein enable a real-world education provider to create a digital version of their organization, governance workflows, learning programs, staff, students, and learning activities. If the organization is qualified on the basis of the digital evidence, it becomes a constituent college within a higher education institution and gains the ability to offer accredited degrees. In some embodiments, on the basis of the records created in software, a higher education institution can issue academic credits and degrees to eligible students. As such, higher education institutions are judged and determined by standards defined by regulation and codified in an Institutional License. The systems, methods, and media herein form a digital record that demonstrates eligibility by an education organization for meeting regulatory standards, and it demonstrates the fulfillment of those standards. Further, in some embodiments, the systems, methods, and media herein change the status of an educational provider from one that does not have accreditation to one that operates under an accreditation license; and our method allows education organizations to create new accredited degree programs that match licenses with government recognition to provide fast and accurate accreditation.

As such, a college and its specific degrees and its specific courses are matched to pre-existing accreditation licenses. Eligible colleges can enroll students and teach accredited degrees. In some embodiments, when multiple licenses exist and match any given college, degree, or course, one or more licenses may be selected on the basis of particular advantages conferred by the license (e.g., providing U.S. accreditation to U.S. students and EU accreditation to EU students).

In one aspect, disclosed herein are computer-implemented systems comprising a computing device comprising at least one processor and instructions executable by the at least one processor to provide an accreditation management system (AMS) comprising: a software module configured to ingest a plurality of educational resources from a remote learning management system (LMS); a software module configured to validate the ingested educational resources by performing content validation operations comprising: applying a cryptographic hash function to each educational resource to generate a content validation hash; generating a unique key for each educational resource; persisting each key in association with its respective educational resource and content validation hash; and sending the keys and associations to the remote LMS; a software module configured to receive a data stream from a computing device of a student user engaged with the educational resources on the remote LMS; a software module configured to validate consumption of the educational resources by the student user by performing consumption validation operations comprising extracting keys from the data stream; and a software module configured to apply an algorithm to generate a confidence level for the consumption validation of the extracted educational resources by performing confidence operations comprising: applying the cryptographic hash function to each educational resource to generate a content consumption hash; and determining a confidence level, at least in part, by comparing the content validation hash to the content consumption hash. In some embodiments, the content validation operations further comprise classifying the educational resources. In some embodiments, the content validation operations further comprise applying a rules-based governance workflow to approve each educational resource. In further embodiments, the educational resources are organized into a cohort, and wherein the content validation operations further comprise applying a rules-based governance workflow to approve the cohort. In some embodiments, each key is associated with its respective educational resource as metadata to the educational resource. In particular embodiments, the cryptographic hash function utilizes a SSHA256 standard. In some embodiments, the data stream from the computing device of the student user is generated by a browser widget, add-in, add-on, or extension. In further embodiments, the data stream from the computing device of the student user is generated by a visible browser widget. In other embodiments, the data stream from the computing device of the student user is generated by an invisible browser widget. In some embodiments, the content validation operations further comprise: applying a keyword analysis algorithm to each educational resource to generate an array of content validation keywords for the educational resource, and persisting each key in association with its respective educational resource and array of content validation keywords. In further embodiments, the array of content validation keywords comprises a frequency for each keyword. In some embodiments, the key word analysis algorithm utilizes one or more neural networks. In some embodiments, the keyword analysis algorithm utilizes one or more regular expression methodologies. In some embodiments, the consumption validation operations further comprise: applying the keyword analysis algorithm to each educational resource to generate an array of content consumption keywords; and further determining the confidence level by comparing the array of content validation keywords to the array of content consumption keywords. In further embodiments, the confidence level is further determined by comparing a frequency of each content validation keyword to a frequency of each content consumption keyword. In some embodiments, the consumption validation operations further comprise: extracting an attendance list from the data stream; and extracting a transcript with speaker attributions from the data stream. In further embodiments, the confidence operations further comprise further determining the confidence level by comparing the attendance list to the speaker attributions. In some embodiments, the confidence operations further comprise further determining the confidence level by comparing confidence levels for other students in a student group. In some embodiments, the consumption validation operations further comprise extracting a screen recording or screen shot from the data stream. In further embodiments, the confidence operations further comprise applying one or more facial detection and identification methodologies to the screen recording or screen shot. In still further embodiments, the confidence operations further comprise further determining the confidence level by comparing an identified face to a known student photo. In some embodiments, each educational resource comprises one or more defined intended learning outcomes (ILOs), at least one workload, and at least one grade weight.

In another aspect, disclosed herein are systems comprising a computing device comprising at least one processor and instructions executable by the at least one processor to provide an accreditation management system (AMS) comprising: a software module configured to validate educational resources by performing content validation operations comprising: ingesting a plurality of educational resources from a remote learning management system (LMS); applying a cryptographic hash function to each educational resource to generate a content validation hash; generating a unique key for each educational resource; persisting each key in association with its respective educational resource and content validation hash; and sending the keys and associations to the remote LMS; a software module configured to receive a data stream from a computing device of a student user engaged with the educational resources on the remote LMS; a software module configured to validate consumption of the educational resources by the student user by performing consumption validation operations comprising extracting keys from the data stream; and a software module configured to apply an algorithm to generate a confidence level for the consumption validation of the extracted educational resources by performing confidence operations comprising: applying the cryptographic hash function to each educational resource to generate a content consumption hash; and determining a confidence level, at least in part, by comparing the content validation hash to the content consumption hash.

In another aspect, disclosed herein are methods comprising: ingesting, at an accreditation management system (AMS), a plurality of educational resources from a remote learning management system (LMS); validating, at the AMS, the ingested educational resources by performing content validation operations comprising: applying a cryptographic hash function to each educational resource to generate a content validation hash; generating a unique key for each educational resource; persisting each key in association with its respective educational resource and content validation hash; and sending the keys and associations to the remote LMS; receiving, at the AMS, a data stream from a computing device of a student user engaged with the educational resources on the remote LMS; validating, at the AMS, consumption of the educational resources by the student user by performing consumption validation operations comprising extracting keys from the data stream; and applying, at the AMS, an algorithm to generate a confidence level for the consumption validation of the extracted educational resources by performing confidence operations comprising: applying the cryptographic hash function to each educational resource to generate a content consumption hash; and determining a confidence level, at least in part, by comparing the content validation hash to the content consumption hash. In some embodiments, the content validation operations further comprise classifying the educational resources. In some embodiments, the content validation operations further comprise applying a rules-based governance workflow to approve each educational resource. In further embodiments, the educational resources are organized into a cohort, and wherein the content validation operations further comprise applying a rules-based governance workflow to approve the cohort. In some embodiments, each key is associated with its respective educational resource as metadata to the educational resource. In particular embodiments, the cryptographic hash function utilizes a SSHA256 standard. In some embodiments, the data stream from the computing device of the student user is generated by a browser widget, add-in, add-on, or extension. In further embodiments, the data stream from the computing device of the student user is generated by a visible browser widget. In other embodiments, the data stream from the computing device of the student user is generated by an invisible browser widget. In some embodiments, the content validation operations further comprise: applying a keyword analysis algorithm to each educational resource to generate an array of content validation keywords for the educational resource, and persisting each key in association with its respective educational resource and array of content validation keywords. In further embodiments, the array of content validation keywords comprises a frequency for each keyword. In some embodiments, the keyword analysis algorithm utilizes one or more neural networks. In some embodiments, the keyword analysis algorithm utilizes one or more regular expression methodologies. In some embodiments, the consumption validation operations further comprise: applying the keyword analysis algorithm to each educational resource to generate an array of content consumption keywords; and further determining the confidence level by comparing the array of content validation keywords to the array of content consumption keywords. In further embodiments, the confidence level is further determined by comparing a frequency of each content validation keyword to a frequency of each content consumption keyword. In some embodiments, the consumption validation operations further comprise: extracting an attendance list from the data stream; and extracting a transcript with speaker attributions from the data stream. In further embodiments, the confidence operations further comprise further determining the confidence level by comparing the attendance list to the speaker attributions. In some embodiments, the confidence operations further comprise further determining the confidence level by comparing confidence levels for other students in a student group. In some embodiments, the consumption validation operations further comprise extracting a screen recording or screen shot from the data stream. In further embodiments, the confidence operations further comprise applying one or more facial detection and identification methodologies to the screen recording or screen shot. In still further embodiments, the confidence operations further comprise further determining the confidence level by comparing an identified face to a known student photo. In some embodiments, each educational resource comprises one or more defined intended learning outcomes (ILOs), at least one workload, and at least one grade weight. In some embodiments, the confidence operations further comprise providing a record for recognition of prior learning, when the confidence level is above a threshold level. In further embodiments, the record for recognition of prior learning allows the consumption of the educational resources by the student user to be converted to academic credit in a degree program. In some embodiments, the method further comprises predicting a likelihood of the student user successfully converting the consumption of the educational resources to credit in a degree program and/or completing a degree program.

In another aspect, disclosed herein are methods comprising: validating, at an accreditation management system (AMS), educational resources by performing content validation operations comprising: ingesting a plurality of educational resources from a remote learning management system (LMS); applying a cryptographic hash function to each educational resource to generate a content validation hash; generating a unique key for each educational resource; persisting each key in association with its respective educational resource and content validation hash; and sending the keys and associations to the remote LMS; receiving, at the AMS, a data stream from a computing device of a student user engaged with the educational resources on the remote LMS; validating, at the AMS, consumption of the educational resources by the student user by performing consumption validation operations comprising extracting keys from the data stream; and applying, at the AMS, an algorithm to generate a confidence level for the consumption validation of the extracted educational resources by performing confidence operations comprising: applying the cryptographic hash function to each educational resource to generate a content consumption hash; and determining a confidence level, at least in part, by comparing the content validation hash to the content consumption hash.

In another aspect, disclosed herein are non-transitory computer-readable storage media encoded with instructions executable by one or more processors to create an education accreditation management application comprising: a database comprising education records; a content ingestion module ingesting a plurality of educational resources from a remote learning management system (LMS); a content validation module performing content validation operations comprising: applying a cryptographic hash function to each educational resource to generate a content validation hash; generating a unique key for each educational resource; persisting each key in association with its respective educational resource and content validation hash; and sending the keys and associations to the remote LMS; a streaming module receiving a data stream from a computing device of a student user engaged with the educational resources on the remote LMS; a content consumption validation module performing consumption validation operations comprising extracting keys from the data stream; and a consumption confidence scoring module applying an algorithm to generate a confidence level for the consumption validation of the extracted educational resources by performing confidence operations comprising: applying the cryptographic hash function to each educational resource to generate a content consumption hash; and determining a confidence level, at least in part, by comparing the content validation hash to the content consumption hash.

In another aspect, disclosed herein are non-transitory computer-readable storage media encoded with instructions executable by one or more processors to create an education accreditation management application comprising: a database comprising education accreditation records; a content validation module performing content validation operations comprising: ingesting a plurality of educational resources from a remote learning management system (LMS); applying a cryptographic hash function to each educational resource to generate a content validation hash; generating a unique key for each educational resource; persisting each key in association with its respective educational resource and content validation hash; and sending the keys and associations to the remote LMS; a streaming module receiving a data stream from a computing device of a student user engaged with the educational resources on the remote LMS; a content consumption validation module performing consumption validation operations comprising extracting keys from the data stream; and a consumption confidence scoring module applying an algorithm to generate a confidence level for the consumption validation of the extracted educational resources by performing confidence operations comprising: applying the cryptographic hash function to each educational resource to generate a content consumption hash; and determining a confidence level, at least in part, by comparing the content validation hash to the content consumption hash.

In another aspect, disclosed herein are computer-implemented systems comprising a computing device comprising at least one processor and instructions executable by the at least one processor to provide an accreditation management system (AMS) comprising: a software module configured to receive a data stream from a computing device of each of a plurality of student users engaged with educational resources on the web; a software module configured to validate each data stream by performing content validation operations comprising: identifying educational resources in the data stream; applying a cryptographic hash function to each educational resource to generate a content validation hash; and persisting each educational resource in association with its content validation hash; and a software module configured to validate subsequent consumption of the educational resources by a particular student user by performing consumption validation operations comprising: identifying educational resources in a data stream from a computing device of the particular student user engaged with educational resources on the web; applying the cryptographic hash function to each educational resource to generate a content consumption hash; and determining a confidence level, at least in part, by comparing the content validation hash to the content consumption hash. In some embodiments, the content validation operations further comprise classifying the educational resources. In some embodiments, the content validation operations further comprise applying a rules-based governance workflow to approve each educational resource. In further embodiments, the educational resources are organized into a cohort, and wherein the content validation operations further comprise applying a rules-based governance workflow to approve the cohort. In some embodiments, the cryptographic hash function utilizes a SSHA256 standard. In some embodiments, the data stream from the computing device of each student user is generated by a browser widget, add-in, add-on, or extension. In further embodiments, the data stream from the computing device of at least one of the student users is generated by a visible browser widget. In other embodiments, the data stream from the computing device of at least one of the student users is generated by an invisible browser widget. In some embodiments, the content validation operations further comprise: applying a keyword analysis algorithm to each educational resource to generate an array of content validation keywords for the educational resource, and persisting each educational resource in association with the array of content validation keywords. In further embodiments, the array of content validation keywords comprises a frequency for each keyword. In further embodiments, the keyword analysis algorithm utilizes one or more neural networks. In further embodiments, the keyword analysis algorithm utilizes one or more regular expression methodologies. In further embodiments, the consumption validation operations further comprise: applying the keyword analysis algorithm to each educational resource to generate an array of content consumption keywords; and further determining the confidence level by comparing the array of content validation keywords to the array of content consumption keywords. In still further embodiments, the confidence level is further determined by comparing a frequency of each content validation keyword to a frequency of each content consumption keyword. In some embodiments, the consumption validation operations further comprise: extracting an attendance list from the data stream; and extracting a transcript with speaker attributions from the data stream. In further embodiments, determining the confidence level is performed, at least in part, by comparing the attendance list to the speaker attributions. In some embodiments, determining the confidence level is performed, at least in part, by comparing confidence levels for other students in a student group. In some embodiments, the consumption validation operations further comprise extracting a screen recording or screen shot from the data stream. In further embodiments, determining the confidence level is performed, at least in part, by applying one or more facial detection and identification methodologies to the screen recording or screen shot. In still further embodiments, determining the confidence level is performed, at least in part, by comparing an identified face to a known student photo. In some embodiments, each educational resource comprises one or more defined intended learning outcomes (ILOs), at least one workload, and at least one grade weight.

In another aspect, disclosed herein are methods comprising: receiving, at an accreditation management system (AMS), a data stream from a computing device of each of a plurality of student users engaged with educational resources on the web; validating, at the AMS, each data stream by performing content validation operations comprising: identifying educational resources in the data stream; applying a cryptographic hash function to each educational resource to generate a content validation hash; and persisting each educational resource in association with its content validation hash; and validating, at the AMS, subsequent consumption of the educational resources by a particular student user by performing consumption validation operations comprising: identifying educational resources in a data stream from a computing device of the particular student user engaged with educational resources on the web; applying the cryptographic hash function to each educational resource to generate a content consumption hash; and determining a confidence level, at least in part, by comparing the content validation hash to the content consumption hash. In some embodiments, the content validation operations further comprise classifying the educational resources. In some embodiments, the content validation operations further comprise applying a rules-based governance workflow to approve each educational resource. In further embodiments, the educational resources are organized into a cohort, and wherein the content validation operations further comprise applying a rules-based governance workflow to approve the cohort. In some embodiments, each key is associated with its respective educational resource as metadata to the educational resource. In some embodiments, the cryptographic hash function utilizes a SSHA256 standard. In some embodiments, the data stream from the computing device of the student user is generated by a browser widget, add-in, add-on, or extension. In further embodiments, the data stream from the computing device of the student user is generated by a visible browser widget. In other embodiments, the data stream from the computing device of the student user is generated by an invisible browser widget. In some embodiments, the content validation operations further comprise: applying a keyword analysis algorithm to each educational resource to generate an array of content validation keywords for the educational resource, and persisting each key in association with its respective educational resource and array of content validation keywords. In further embodiments, the array of content validation keywords comprises a frequency for each keyword. In further embodiments, the keyword analysis algorithm utilizes one or more neural networks. In further embodiments, the keyword analysis algorithm utilizes one or more regular expression methodologies. In further embodiments, the consumption validation operations further comprise: applying the keyword analysis algorithm to each educational resource to generate an array of content consumption keywords; and further determining the confidence level by comparing the array of content validation keywords to the array of content consumption keywords. In still further embodiments, the confidence level is further determined by comparing a frequency of each content validation keyword to a frequency of each content consumption keyword. In some embodiments, the consumption validation operations further comprise: extracting an attendance list from the data stream; and extracting a transcript with speaker attributions from the data stream. In further embodiments, the confidence operations further comprise further determining the confidence level by comparing the attendance list to the speaker attributions. In some embodiments, the confidence operations further comprise further determining the confidence level by comparing confidence levels for other students in a student group. In some embodiments, the consumption validation operations further comprise extracting a screen recording or screen shot from the data stream. In further embodiments, the confidence operations further comprise applying one or more facial detection and identification methodologies to the screen recording or screen shot. In still further embodiments, the confidence operations further comprise further determining the confidence level by comparing an identified face to a known student photo. In some embodiments, each educational resource comprises one or more defined intended learning outcomes (ILOs), at least one workload, and at least one grade weight. In some embodiments, the consumption validation operations further comprise providing a record for recognition of prior learning, when the confidence level is above a threshold level. In further embodiments, the record for recognition of prior learning allows the consumption of the educational resources by the student user to be converted to academic credit in a degree program. In some embodiments, the method further comprises predicting a likelihood of the student user successfully converting the consumption of the educational resources to credit in a degree program and/or completing a degree program.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 shows a non-limiting example of a computing device; in this case, a device with one or more processors, memory, storage, and a network interface;

FIG. 2 shows a non-limiting example of a web/mobile application provision system; in this case, a system providing browser-based and/or native mobile user interfaces;

FIG. 3 shows a non-limiting example of a cloud-based web/mobile application provision system; in this case, a system comprising an elastically load balanced, auto-scaling web server and application server resources as well synchronously replicated databases;

FIG. 4 shows a non-limiting example of a schematic process diagram; in this case, a process for college accreditation;

FIG. 5 shows a non-limiting example of a schematic process diagram; in this case, a process for degree and course accreditation;

FIG. 6 shows a non-limiting example of a schematic process diagram; in this case, a process for substituting one course for another course in order to fulfill a degree license requirement;

FIG. 7 shows a non-limiting example of a schematic process diagram; in this case, a first process for transferring course credits from one institutional license to another institutional license to fulfill degree requirements under the second institutional license and degree license;

FIG. 8 shows a non-limiting example of a schematic process diagram; in this case, a second process for transferring course credits from one institutional license to another institutional license to fulfill degree requirements under the second institutional license and degree license;

FIG. 9A shows a non-limiting example of a schematic architecture diagram; in this case, a architecture for implementing an AMS with a remote LMS as described herein to develop a level of confidence that a student has fulfilled requirements for consuming an educational resource, a course, a cohort, or the like; and

FIG. 9B shows a non-limiting example of a schematic architecture diagram; in this case, a architecture for an AMS as described herein.

### DETAILED DESCRIPTION

Described herein, in certain embodiments, are computer-implemented systems comprising a computing device comprising at least one processor and instructions executable by the at least one processor to provide an accreditation management system (AMS) comprising: a software module configured to ingest a plurality of educational resources from a remote learning management system (LMS); a software module configured to validate the ingested educational resources by performing content validation operations comprising: applying a cryptographic hash function to each educational resource to generate a content validation hash; generating a unique key for each educational resource; persisting each key in association with its respective educational resource and content validation hash; and sending the keys and associations to the remote LMS; a software module configured to receive a data stream from a computing device of a student user engaged with the educational resources on the remote LMS; a software module configured to validate consumption of the educational resources by the student user by performing consumption validation operations comprising extracting keys from the data stream; and a software module configured to apply an algorithm to generate a confidence level for the consumption validation of the extracted educational resources by performing confidence operations comprising: applying the cryptographic hash function to each educational resource to generate a content consumption hash; and determining a confidence level, at least in part, by comparing the content validation hash to the content consumption hash.

Also described herein, in certain embodiments, are systems comprising a computing device comprising at least one processor and instructions executable by the at least one processor to provide an accreditation management system (AMS) comprising: a software module configured to validate educational resources by performing content validation operations comprising: ingesting a plurality of educational resources from a remote learning management system (LMS); applying a cryptographic hash function to each educational resource to generate a content validation hash; generating a unique key for each educational resource; persisting each key in association with its respective educational resource and content validation hash; and sending the keys and associations to the remote LMS; a software module configured to receive a data stream from a computing device of a student user engaged with the educational resources on the remote LMS; a software module configured to validate consumption of the educational resources by the student user by performing consumption validation operations comprising extracting keys from the data stream; and a software module configured to apply an algorithm to generate a confidence level for the consumption validation of the extracted educational resources by performing confidence operations comprising: applying the cryptographic hash function to each educational resource to generate a content consumption hash; and determining a confidence level, at least in part, by comparing the content validation hash to the content consumption hash.

Also described herein, in certain embodiments, are methods comprising: ingesting, at an accreditation management system (AMS), a plurality of educational resources from a remote learning management system (LMS); validating, at the AMS, the ingested educational resources by performing content validation operations comprising: applying a cryptographic hash function to each educational resource to generate a content validation hash; generating a unique key for each educational resource; persisting each key in association with its respective educational resource and content validation hash; and sending the keys and associations to the remote LMS; receiving, at the AMS, a data stream from a computing device of a student user engaged with the educational resources on the remote LMS; validating, at the AMS, consumption of the educational resources by the student user by performing consumption validation operations comprising extracting keys from the data stream; and applying, at the AMS, an algorithm to generate a confidence level for the consumption validation of the extracted educational resources by performing confidence operations comprising: applying the cryptographic hash function to each educational resource to generate a content consumption hash; and determining a confidence level, at least in part, by comparing the content validation hash to the content consumption hash.

Also described herein, in certain embodiments, are methods comprising: validating, at an accreditation management system (AMS), educational resources by performing content validation operations comprising: ingesting a plurality of educational resources from a remote learning management system (LMS); applying a cryptographic hash function to each educational resource to generate a content validation hash; generating a unique key for each educational resource; persisting each key in association with its respective educational resource and content validation hash; and sending the keys and associations to the remote LMS; receiving, at the AMS, a data stream from a computing device of a student user engaged with the educational resources on the remote LMS; validating, at the AMS, consumption of the educational resources by the student user by performing consumption validation operations comprising extracting keys from the data stream; and applying, at the AMS, an algorithm to generate a confidence level for the consumption validation of the extracted educational resources by performing confidence operations comprising: applying the cryptographic hash function to each educational resource to generate a content consumption hash; and determining a confidence level, at least in part, by comparing the content validation hash to the content consumption hash.

Also described herein, in certain embodiments, are non-transitory computer-readable storage media encoded with instructions executable by one or more processors to create an education accreditation management application comprising: a database comprising education records; a content ingestion module ingesting a plurality of educational resources from a remote learning management system (LMS); a content validation module performing content validation operations comprising: applying a cryptographic hash function to each educational resource to generate a content validation hash; generating a unique key for each educational resource; persisting each key in association with its respective educational resource and content validation hash; and sending the keys and associations to the remote LMS; a streaming module receiving a data stream from a computing device of a student user engaged with the educational resources on the remote LMS; a content consumption validation module performing consumption validation operations comprising extracting keys from the data stream; and a consumption confidence scoring module applying an algorithm to generate a confidence level for the consumption validation of the extracted educational resources by performing confidence operations comprising: applying the cryptographic hash function to each educational resource to generate a content consumption hash; and determining a confidence level, at least in part, by comparing the content validation hash to the content consumption hash.

Also described herein, in certain embodiments, are non-transitory computer-readable storage media encoded with instructions executable by one or more processors to create an education accreditation management application comprising: a database comprising education accreditation records; a content validation module performing content validation operations comprising: ingesting a plurality of educational resources from a remote learning management system (LMS); applying a cryptographic hash function to each educational resource to generate a content validation hash; generating a unique key for each educational resource; persisting each key in association with its respective educational resource and content validation hash; and sending the keys and associations to the remote LMS; a streaming module receiving a data stream from a computing device of a student user engaged with the educational resources on the remote LMS; a content consumption validation module performing consumption validation operations comprising extracting keys from the data stream; and a consumption confidence scoring module applying an algorithm to generate a confidence level for the consumption validation of the extracted educational resources by performing confidence operations comprising: applying the cryptographic hash function to each educational resource to generate a content consumption hash; and determining a confidence level, at least in part, by comparing the content validation hash to the content consumption hash.

Also described herein, in certain embodiments, are computer-implemented systems comprising a computing device comprising at least one processor and instructions executable by the at least one processor to provide an accreditation management system (AMS) comprising: a software module configured to receive a data stream from a computing device of each of a plurality of student users engaged with educational resources on the web; a software module configured to validate each data stream by performing content validation operations comprising: identifying educational resources in the data stream; applying a cryptographic hash function to each educational resource to generate a content validation hash; and persisting each educational resource in association with its content validation hash; and a software module configured to validate subsequent consumption of the educational resources by a particular student user by performing consumption validation operations comprising: identifying educational resources in a data stream from a computing device of the particular student user engaged with educational resources on the web; applying the cryptographic hash function to each educational resource to generate a content consumption hash; and determining a confidence level, at least in part, by comparing the content validation hash to the content consumption hash.

Also described herein, in certain embodiments, are methods comprising: receiving, at an accreditation management system (AMS), a data stream from a computing device of each of a plurality of student users engaged with educational resources on the web; validating, at the AMS, each data stream by performing content validation operations comprising: identifying educational resources in the data stream; applying a cryptographic hash function to each educational resource to generate a content validation hash; and persisting each educational resource in association with its content validation hash; and validating, at the AMS, subsequent consumption of the educational resources by a particular student user by performing consumption validation operations comprising: identifying educational resources in a data stream from a computing device of the particular student user engaged with educational resources on the web; applying the cryptographic hash function to each educational resource to generate a content consumption hash; and determining a confidence level, at least in part, by comparing the content validation hash to the content consumption hash.

### Certain Definitions

Unless otherwise defined, all technical terms used herein have the same meaning as commonly understood by one of ordinary skill in the art to which the present subject matter belongs.

As used in this specification and the appended claims, the singular forms “a,” “an,” and “the” include plural references unless the context clearly dictates otherwise. Any reference to “or” herein is intended to encompass “and/or” unless otherwise stated.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

As used herein, the term “accreditation” is a recognition that a provider or program meets standards defined by a third-party, typically a government agency, regulator, or government-recognized body.

As used herein, the term “airlock” refers to a system for handling learning content and student learning activities on a remote learning platform. Airlock may be composed of an SDK with a visible widget, an API, and webhooks.

As used herein, the term “approval group” refers to a role-based access control group with defined parameters for admission (e.g., status as a college Staff member and a required education level). Only members of a designated Approval Group may determine the outcome of a Governance Workflow.

As used herein, the term “college” is a status earned when a provider becomes a constituent member colleges of an Institutional License.

As used herein, the term “college staff” refers to members of a college with roles and permissions defined in software-including teachers, administrators, and academic board members.

As used herein, the term “college student” refers to a members of a course or degree learning activity.

As used herein, the term “cohort” refers to a package of resources within a course, grouped into lessons

As used herein, the term “course” refers to a bounded education module, composed of learning resources (e.g., videos, quizzes, readings, assignments) that may be organized into lessons.

As used herein, the term “credits” refers to a token awarded to a student upon completion of a course. The student may be required to meet minimum credit requirements to achieve a degree, along with other conditions.

As used herein, the term “degree” refers to a set of one or more courses; except in the case of PhD degrees, a degree has a set number of credits.

As used herein, the term “governance workflow” refers to an approval process with rules defined in software, in which a request is made to an Approval Group, and one or more members of an Approval Group must approve of the request (e.g., a request to be admitted to a college or to add final scores to a Student's transcript).

As used herein, the term “grade weight” refers to a value indicating the percentage of the final score to which the average of all scores in that grade weight will contribute. For example, quizzes might be 25% and a final project might be 50%.

As used herein, the term “Hard Quality Assurance (HQA) Standard” refers to benchmarks that must be met by an entity, staff member or student, or program to match the standards of a license.

As used herein, the term “Institutional License” refers to a legally incorporated entity that is a degree-granting collegiate higher education institution. Each entity is composed of constituent member colleges, and each college operates semi-independently within the strict regulations of the Institutional License. Legacy examples of collegiate higher education institutions include the University of Oxford and the University of London.

As used herein, the term “Intended Learning Outcomes (ILO)” refers to a part of the license for any course and can be linked to an assignment in that course.

As used herein, the term “provider” refers to an educational institution or organization, regardless of accreditation status. For example, an online bootcamp, group of academic researchers, or brick-and-mortar college.

As used herein, the term “program” refers to an organized educational activity, regardless of accreditation status.

As used herein, the term “resource” refers to a learning tool such as videos, quizzes, reading materials, assignments, and other learning activities. These are the building blocks of a course.

As used herein, the term “Student Information System (SIS)” refers to a record keeping system with the names and details of students, including which courses they have completed

As used herein, the term “Quality Assurance (QA)” refers to a comprehensive set of processes by which a provider ensures that its Programs and activities meet Accreditation standards.

As used herein, the term “Soft Quality Assurance (SQA)” refers to a set of benchmarks including a specific score must be achieved for an entity, staff member or student, or program to match the standards of a license. These soft standards have an aggregate threshold requirement.

As used herein, the term “validation” refers to a confirmation that all HQA and SQA standards must be met.

As used herein, the term “workload” refers to a designated number of hours a student is expected to engage with the resource. For example, a quiz might be 1 hour.

### Computing System

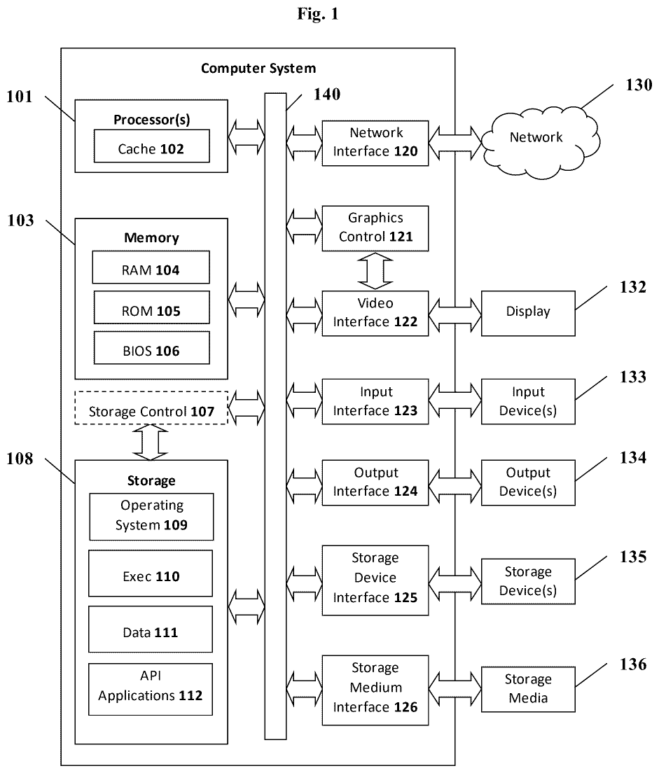

Referring to FIG. 1, a block diagram is shown depicting an exemplary machine that includes a computer system 100 (e.g., a processing or computing system) within which a set of instructions can execute for causing a device to perform or execute any one or more of the aspects and/or methodologies for static code scheduling of the present disclosure. The components in FIG. 1 are examples only and do not limit the scope of use or functionality of any hardware, software, embedded logic component, or a combination of two or more such components implementing particular embodiments.

Computer system 100 may include one or more processors 101, a memory 103, and a storage 108 that communicate with each other, and with other components, via a bus 140. The bus 140 may also link a display 132, one or more input devices 133 (which may, for example, include a keypad, a keyboard, a mouse, a stylus, etc.), one or more output devices 134, one or more storage devices 135, and various tangible storage media 136. All of these elements may interface directly or via one or more interfaces or adaptors to the bus 140. For instance, the various tangible storage media 136 can interface with the bus 140 via storage medium interface 126. Computer system 100 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 100 includes one or more processor(s) 101 (e.g., central processing units (CPUs), general purpose graphics processing units (GPGPUs), or quantum processing units (QPUs)) that carry out functions. Processor(s) 101 optionally contains a cache memory unit 102 for temporary local storage of instructions, data, or computer addresses. Processor(s) 101 are configured to assist in execution of computer readable instructions. Computer system 100 may provide functionality for the components depicted in FIG. 1 as a result of the processor(s) 101 executing non-transitory, processor-executable instructions embodied in one or more tangible computer-readable storage media, such as memory 103, storage 108, storage devices 135, and/or storage medium 136. The computer-readable media may store software that implements particular embodiments, and processor(s) 101 may execute the software. Memory 103 may read the software from one or more other computer-readable media (such as mass storage device(s) 135, 136) or from one or more other sources through a suitable interface, such as network interface 120. The software may cause processor(s) 101 to carry out one or more processes or one or more steps of one or more processes described or illustrated herein. Carrying out such processes or steps may include defining data structures stored in memory 103 and modifying the data structures as directed by the software.

The memory 103 may include various components (e.g., machine readable media) including, but not limited to, a random access memory component (e.g., RAM 104) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 105 may act to communicate data and instructions unidirectionally to processor(s) 101, and RAM 104 may act to communicate data and instructions bidirectionally with processor(s) 101. ROM 105 and RAM 104 may include any suitable tangible computer-readable media described below. In one example, a basic input/output system 106 (BIOS), including basic routines that help to transfer information between elements within computer system 100, such as during start-up, may be stored in the memory 103.

Fixed storage 108 is connected bidirectionally to processor(s) 101, optionally through storage control unit 107. Fixed storage 108 provides additional data storage capacity and may also include any suitable tangible computer-readable media described herein. Storage 108 may be used to store operating system 109, executable(s) 110, data 111, applications 112 (application programs), and the like. Storage 108 can also include an optical disk drive, a solid-state memory device (e.g., flash-based systems), or a combination of any of the above. Information in storage 108 may, in appropriate cases, be incorporated as virtual memory in memory 103.

In one example, storage device(s) 135 may be removably interfaced with computer system 100 (e.g., via an external port connector (not shown)) via a storage device interface 125. Particularly, storage device(s) 135 and an associated machine-readable medium may provide non-volatile and/or volatile storage of machine-readable instructions, data structures, program modules, and/or other data for the computer system 100. In one example, software may reside, completely or partially, within a machine-readable medium on storage device(s) 135. In another example, software may reside, completely or partially, within processor(s) 101.

Bus 140 connects a wide variety of subsystems. Herein, reference to a bus may encompass one or more digital signal lines serving a common function, where appropriate. Bus 140 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 100 may also include an input device 133. In one example, a user of computer system 100 may enter commands and/or other information into computer system 100 via input device(s) 133. Examples of an input device(s) 133 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 133 may be interfaced to bus 140 via any of a variety of input interfaces 123 (e.g., input interface 123) including, but not limited to, serial, parallel, game port, USB, FIREWIRE, THUNDERBOLT, or any combination of the above.

In particular embodiments, when computer system 100 is connected to network 130, computer system 100 may communicate with other devices, specifically mobile devices and enterprise systems, distributed computing systems, cloud storage systems, cloud computing systems, and the like, connected to network 130. Communications to and from computer system 100 may be sent through network interface 120. For example, network interface 120 may receive incoming communications (such as requests or responses from other devices) in the form of one or more packets (such as Internet Protocol (IP) packets) from network 130, and computer system 100 may store the incoming communications in memory 103 for processing. Computer system 100 may similarly store outgoing communications (such as requests or responses to other devices) in the form of one or more packets in memory 103 and communicated to network 130 from network interface 120. Processor(s) 101 may access these communication packets stored in memory 103 for processing.

Examples of the network interface 120 include, but are not limited to, a network interface card, a modem, and any combination thereof. Examples of a network 130 or network segment 130 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 130, may employ a wired and/or a wireless mode of communication. In general, any network topology may be used.

Information and data can be displayed through a display 132. Examples of a display 132 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 132 can interface to the processor(s) 101, memory 103, and fixed storage 108, as well as other devices, such as input device(s) 133, via the bus 140. The display 132 is linked to the bus 140 via a video interface 122, and transport of data between the display 132 and the bus 140 can be controlled via the graphics control 121. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 132, computer system 100 may include one or more other peripheral output devices 134 including, but not limited to, an audio speaker, a printer, a storage device, and any combinations thereof. Such peripheral output devices may be connected to the bus 140 via an output interface 124. Examples of an output interface 124 include, but are not limited to, a serial port, a parallel connection, a USB port, a FIREWIRE port, a THUNDERBOLT port, and any combinations thereof.

In addition or as an alternative, computer system 100 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, cloud computing platforms, distributed computing platforms, server clusters, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, which perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® ActionScript, JavaScript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

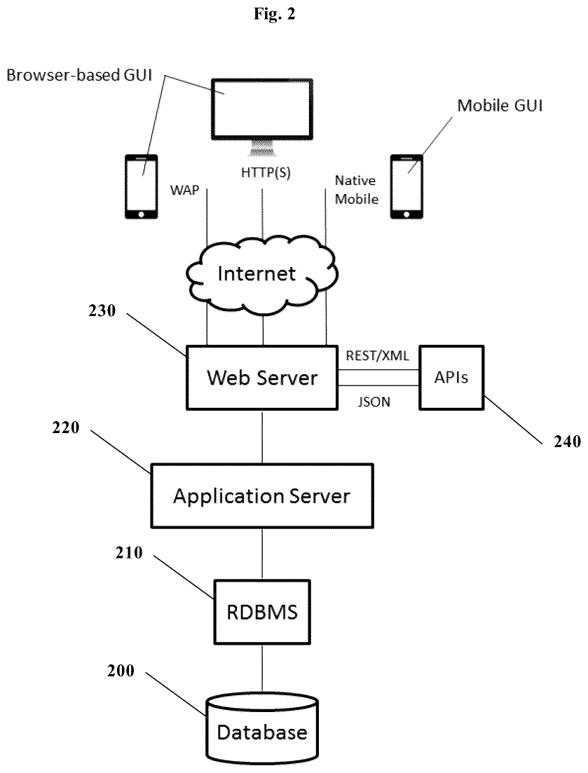

Referring to FIG. 2, in a particular embodiment, an application provision system comprises one or more databases 200 accessed by a relational database management system (RDBMS) 210. Suitable RDBMSs include Firebird, MySQL, PostgreSQL, SQLite, Oracle Database, Microsoft SQL Server, IBM DB2, IBM Informix, SAP Sybase, Teradata, and the like. In this embodiment, the application provision system further comprises one or more application severs 220 (such as Java servers, .NET servers, PHP servers, and the like) and one or more web servers 230 (such as Apache, IIS, GWS and the like). The web server(s) optionally expose one or more web services via app application programming interfaces (APIs) 240. Via a network, such as the Internet, the system provides browser-based and/or mobile native user interfaces.

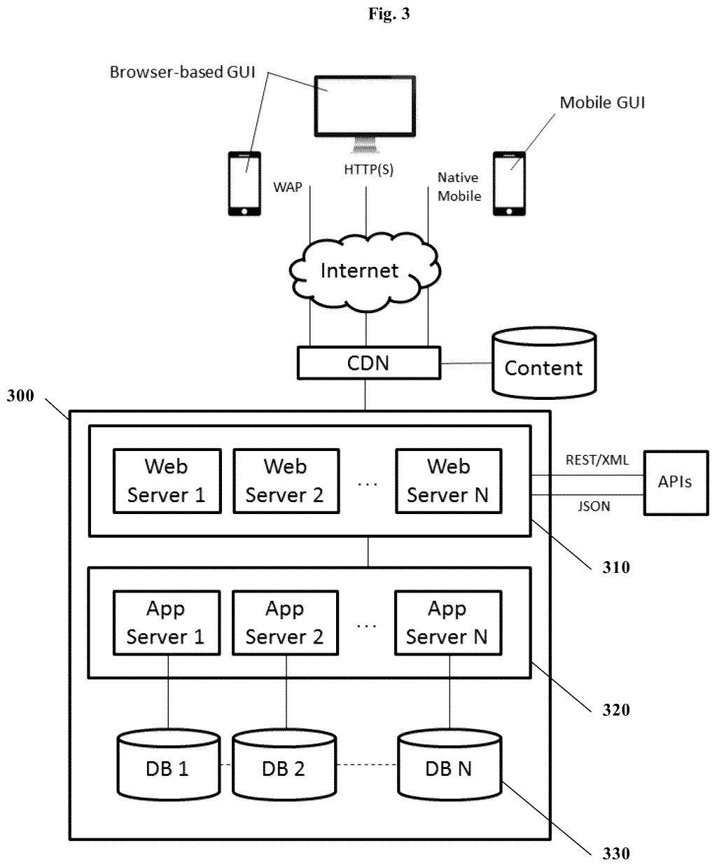

Referring to FIG. 3, in a particular embodiment, an application provision system alternatively has a distributed, cloud-based architecture 300 and comprises elastically load balanced, auto-scaling web server resources 310 and application server resources 320 as well synchronously replicated databases 330.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, JavaScript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, Airplay SDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and PhoneGap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome Web Store, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB.NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB.NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of college, student, degree, course, educational resource, key, hash, keyword, and other validation information. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### General Quality Assurance System

The systems, methods, and media herein benchmark providers and their programs, matching them to institutional licenses and degree licenses. our method ensures that all connections in a sequence of validation checks are valid in order for any credits to be issued to a student. Further, the systems, methods, and media herein track and monitor colleges, degrees, courses, resources, college staff, college staff activities (including teaching), college students, and student learning. The systems, methods, and media herein also provide accountability by detecting that QA standards are met, and validating a program accordingly.

Valid processes and programs may be matched to accreditation licenses and are available to college staff and students. Invalid members, processes or programs may become instantly unavailable to college staff and students. In some embodiments, validity has both HQA standards and SQA standards, wherein all or a variable subset of processes and roles have required HQA standards that must be met.

### College Accreditation

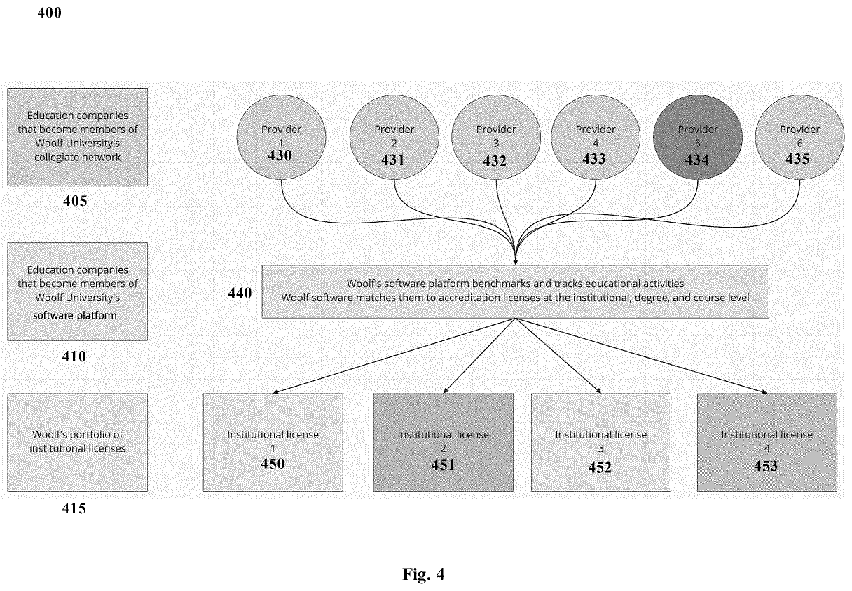

In some embodiments, per FIG. 4, is a process to perform a college accreditation 400. As shown, in one example education companies that become members of the collegiate network 405 comprise a first provider, 430, a second provider 431, a third provider 432, a fourth provider 433, a fifth provider 434, and a sixth provider 435. Further, as shown, education companies that become members of the software platform 410 are used to benchmark and track educational activities to match the activities received from accredited licenses, institutions 430 431 432 433 434 435, degrees, and course levels 440. Finally, the benchmarked and tracked educational activities 440 are provided to a portfolio of institution licenses 415, comprising a first institutional license 450, a second institutional license 451, a third institutional license 452, and a fourth institutional license 453.

In some embodiments, a provider is matched to an institutional license, thereby changing the status of an provider to a member college of an accredited institution with the ability to enroll students in degrees and courses and issue credits.

Information about a provider is captured in software and when the information is complete, the provider is matched to an institutional license. The provider may become a member college of more than one institutional license, and thereby gain access to all of the degree licenses within that institution, and issue degrees out of multiple institutions and their respective jurisdictions.

A college is matched to a license by our method when the college passes all the checks as a valid member of the licensed institution. A college may be eligible for more membership in more than one licensed institution, which provides further benefits. college maintains its membership just as long as it maintains all of its validation checks.

Institutional licenses require that member colleges meet and maintain specific quality standards, including the education level of the members, specific roles and permissions, and the adoption of Governance Workflows, including the segregation of responsibilities into approval committees with membership requirements for those committees. As such, the systems, methods, and media herein uniquely accomplish these tasks in real time and guarantees their enforcement through automatic rules.

### HQA Standards for a College

When a provider seeks to obtain or maintain the status of a college, they must fulfill HQA standards. The systems, methods, and media herein create a software template of the college with all of the parameters required to fulfill the requirements. The template college contains all of the Governance Workflows required for institutional license membership, and it records an inspectable record in real time of all college activities, such as when a valid Approval Group invites a new college Staff member to join or approves the final scores on the transcript for a college students.

Validation checks for meeting and maintaining the requirements may comprise ensuring that:
the college has a valid dean with a valid ID;
the college has a valid approval group; the “academic board” with the ability to decide some governance workflows;
the academic board has 2 members with verified IDs and PhDs;
the college has staff with appropriate education levels for the programs taught;
the faculty members and instructors and professional experts have verified IDs, verified PhDs;
the college has a valid staff with valid IDs to perform administrative activities and they must be assigned to those approval groups; or
any combination thereof.

### SQA College Standards

In order to meet and maintain their validation checks, the systems, methods, and media herein determine an overall quality of the college. The quality requirements can be dynamically allocated by, for example, requiring that as the number of active college students increases so must the number of active college staff. In another example, only colleges with a satisfactory score in a student survey can increase their number of valid degrees. In some embodiments, the quality of college is determined by:
a number of PhDs;
a number of valid degrees;
a number of valid courses;
an average number of students enrolled in the last X number months;
an average staff survey score for the staff survey;
an average student survey score;
a number of weekly active staff;
a number of weekly active students; or
any combination thereof.

The threshold for a college to maintain their validation status may be determined by the HQA standards, the SQA standards, or both. In some embodiments, an invalidated college automatically loses its ability to enroll further students. Since all of the information is recorded in real time, in some embodiments, college staff and regulators can easily see at any time whether a college is likely to fall below a validation threshold to take remedial action.

### Degree and Course Accreditation

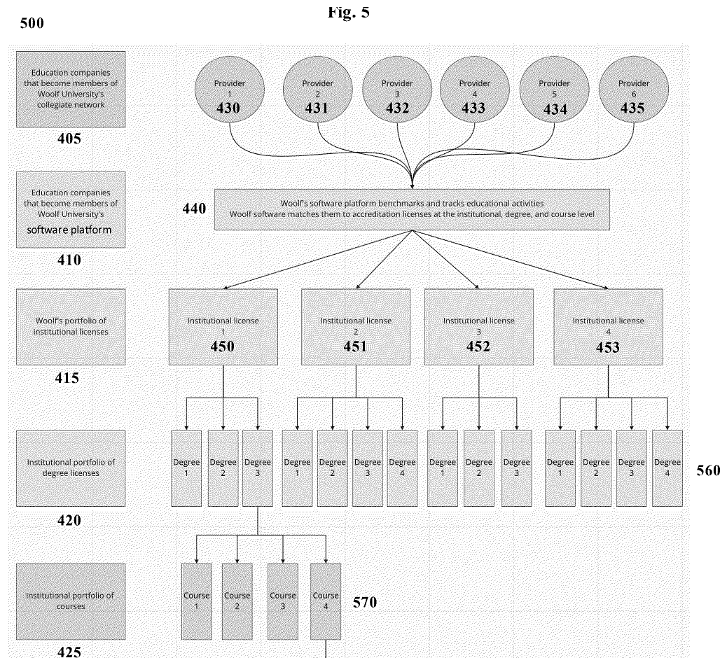

In some embodiments, per FIG. 5, is a process to perform a degree and course accreditation 500. As shown, in one example education companies that become members of the collegiate network 405 comprise a first provider, 430, a second provider 431, a third provider 432, a fourth provider 433, a fifth provider 434, and a sixth provider 435. Further, as shown, education companies that become members of the software platform 410 are used to benchmark and track educational activities to match the activities received from accredited licenses, institutions 430 431 432 433 434 435, degrees, and course levels 440. Additionally, the benchmarked and tracked educational activities 440 are provided to a portfolio of institution licenses 415, comprising a first institutional license 450, a second institutional license 451, a third institutional license 452, and a fourth institutional license 453. Further as shown, each institutional license 450 451 452 453 is associated with one or more degrees 560 in an institutional portfolio of degree licenses 420, wherein each degree 560 is associated with a course 570 in the institutional portfolio of courses.

To offer a degree, a college must obtain and maintain a valid degree status by fulfilling the HQA standards. A valid college must be a member of an institution license, wherein members have access to the degree licenses of that institution license. The systems, methods, and media herein employ a software template of a degree and its courses, wherein the template includes all of the parameters and rules required to fulfill the degree license requirements within an institution license where the college is a valid member. In some embodiments, the template of the degree defines all the validation checks required for the degree and its courses to maintain their validation.

In some embodiments, only valid degrees can enroll students, and students can only enroll in valid courses for valid degrees in a valid colleges.

### Degree Validation

In some embodiments, the systems, methods, and media herein determine whether a degree meets and maintains validation checks in real time. Valid degrees must meet both HQA and SQA standards. HQA standards for a degree may be that the degree:
is offered by a valid college;
fulfils profile parameters of degree licenses such as:
   education levels (e.g., undergraduate, postgraduate, doctoral);
   set workload/credits for degree completion;
   instructors having certain learning requirements;
   education level of all students in a degree; and/or
   sets intended learning outcomes;
fulfils profile parameters of degree structure such as:
   being composed of tiers that are assigned workload/credits requirements that match license requirements; and/or
   having a sum workload/credits of all tiers equals the License requirement for sum degree workload/credits requirements;
is approved in software by correct approval committee;
is composed of valid courses; or
any combination thereof.

### SQA Degree Standards

In order to meet and maintain their validation checks, the systems, methods, and media herein query data in real time to determine the overall quality of the degree and its courses. The quality requirements may be dynamically adjustable, wherein for example, as the number of active college students increases in a course, so must the number of active college staff, or as another example, that only degrees or courses with a satisfactory score in a student survey can increase their number of active students. The following standards must be met for sufficient degree quality:
each tier in the degree has valid courses with equal or greater number of sum credits to fulfill credit workload requirements for tier;
each course in each tier is open for enrollment or has open enrollment dates in the future;
each course in each tier has a staff survey approval average score greater than a set threshold;
each course in each tier has a student survey approval average score greater than a set threshold;
each course in each tier has a set number of monthly active staff;
each course in each tier has a set number of monthly active students; or
any combination thereof.

### HQA Course Profile Standards

In some embodiments, all degrees must be composed of valid courses that meet both HQA and SQA requirements. HQA course profile standards may require a course to:
offer by a valid college matched to an institutional license;
be approved by the relevant approval committee for matching the institutional license;
have a general profile matches the license profile, such as, for example:
   course level requirements (lower undergraduate, upper undergraduate, postgraduate, and doctoral);
   course credit/workload amount requirements;
   course instructor educational level requirements;
   course student education level requirements;
   course ILOs requirements;
   course grade weight requirements; or
   any combination thereof; and/or
have a resource library profile that matches the license profile, including:
   having a set resource difficulty level;
   having a minimum number of resources for any resource kind;
   having a minimum resource workloads; or
   any combination thereof.

### SQA Course Profile Standards

In further embodiments, the educational resources are organized into a cohort, and wherein the content validation operations further comprise applying a rules-based governance workflow to approve the cohort. In some embodiments, all degrees must be composed of valid courses that meet both HQA and SQA requirements. SQA course profile standards may require a course to:
have at least a set number of PhDs;
have at least a set number of master's degrees;
offer at least a set number of valid resources of each resource kind;
have at least a set number of students enrolled in the last X months;
have a set average score for the staff survey;
have a set average score for the student survey;
have at least a set number of weekly active staff;
have at least a set number of weekly active students;
have a valid cohort;
contain resources that meet all of the course profile HQA requirements;
have college staff that meet the course profile HQA requirements; or
any combination thereof

### Fulfillment of Eligibility Requirements and Issue Academic Credits and Degrees

In some embodiments, the systems, methods, and media herein employ software to determine fulfillment of the eligibility criteria comprehensively, accurately, accountably, and quickly. In some embodiments, once the profile requirements are defined for a college, degree, and course, the contents and learning activities therein must be analyzed to confirm satisfaction of requirements. In some embodiments, the content validation operations further comprise classifying the educational resources. In some embodiments, the content validation operations further comprise applying a rules-based governance workflow to approve each educational resource.

In some embodiments, the systems, methods, and media herein demonstrate the fulfillment of the profile requirements for a college, degree, course, or resource by determining whether the HQA and SQA profile requirements have been met or not. If any requirement is determined not to be fulfilled, the college, degree, or course is invalid and is barred from admitting new students and staff or contributing to academic credits

In some embodiments, the systems, methods, and media herein create a record in real time of the validation checks, governance workflow approvals, staff activity, and student activity. In some embodiments, whenever actions are performed by a user, these are attributed to that user and recorded in real time.

For a student to earn a degree in a course at an institution, all must be validated according to their requirements. Additionally, to earn a degree, the student must successfully complete all of the learning content by consuming and/or manipulating educational resources which have defined ILOs, workloads, and grade weights. In some embodiments, successful completion requires receiving a grade.

In one example, all learning activities may occur directly on a local LMS through the same software server as the record-keeping system, wherein the LMS is designed to produce records for the record-keeping system. In another example, all learning activities occur on a remote LMS, hosted on a server outside the direct control of the record keeping system. Such an LMS may not be designed to serve the record-keeping system.

### Method for Demonstrating Fulfillment of Requirements by a Student on a Remote LMS

In some embodiments, the systems, methods, and media herein validate the learning activities of a student on a remote LMS, in order to demonstrate that the student fulfills all of the requirements located on the record-keeping system.

In some embodiments, validating the learning activities of a student on a remote LMS comprises validating that a resource has:
an API connection between the remote LMS and record-keeping system;
a copy of all learning resources that is sent from the remote database to the record keeping system;
resources that meet the requirements of the accreditation license meet the requirements of the resource library, wherein classification of resources can be performed remotely or locally, and wherein approval of resources can be automatic or by a governance workflow;
approved resource files are processed to create one or more secret keys;
meets the requirements of the resource library;
keys that can be stored as metadata; or
any combination thereof.

In some embodiments, validating the learning activities of a student on a remote LMS comprises validating a connection between the student to a college record-keeping system, wherein the record keeping system:
installs SDK on the remote LMS;
employs visible pop up notifications requiring all users of remote LMS to complete staff or students requirements;
authorizes a students in both remote LMS and the record-keeping system; or
any combination thereof.

In some embodiments, validating the learning activities of a student on a remote LMS comprises validating the degree, and course requirements, wherein onboard staff are validated for their requirements and are assigned to a role (e.g., an approval groups) courses to teach. In some embodiments, onboard students are validated according to requirements and assign to degrees and courses.

In some embodiments, validating the learning activities of a student on a remote LMS comprises validating a consumption of resources by confirming that:
all approved resources on remote LMS contain the key in their metadata;
any modified resource associated keys are at least partially broken;
students that consume a resource on the remote LMS also consume the key associated with that resource;
all remote client-side browser events for the student are streamed to the local server when a student is logged into both platforms;
the local server listens for keys;
the local server runs an evaluation to determine whether a received key is intact or has been at least partially broken; or
any combination thereof.

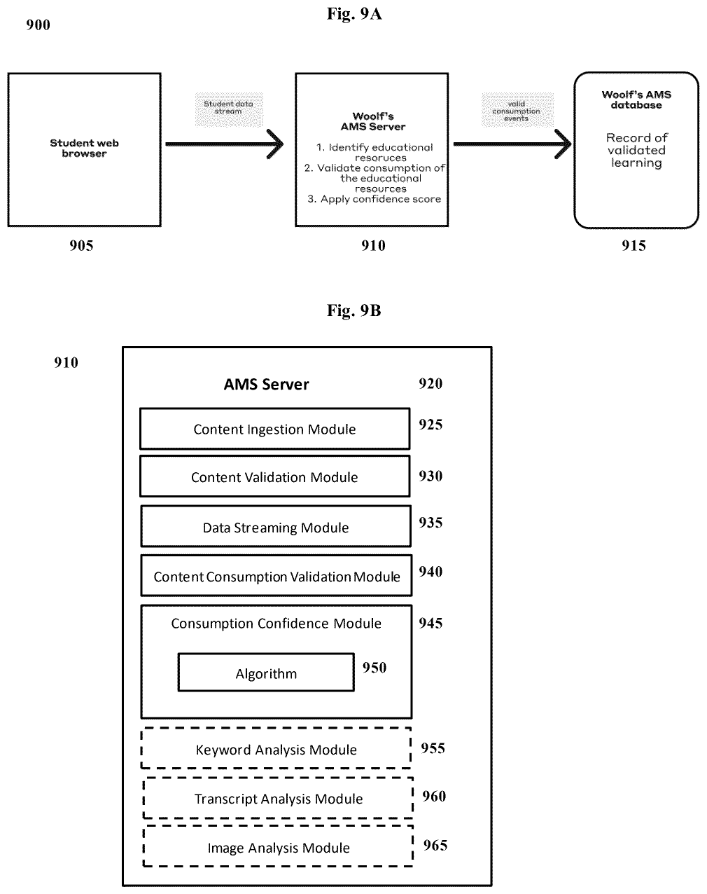

Referring to FIG. 9A, in some embodiments, the platforms and systems comprise, and the methods utilize, a high-level schematic architecture 900 including: a student web browser 905 that has been configured to generate and transmit a student data stream, an AMS server 910 configured to receive the student data stream, identify in the data stream educational resource(s) consumed by the student, validate the student's consumption of the educational resource(s), and apply an algorithm to generate a confidence level and/or score that the student has met the requirements for consumption of the educational resource(s), and a AMS database 915 configured to maintain records of validated learning. In further embodiments, the AMS server 910 and AMS database 915 generate an audit trail to demonstrate a validation history for the student's learning.

In some embodiments, validating the learning activities of a student on a remote LMS comprises determining a confidence that the student has consumed the resources. In some embodiments, key consumption by kind confirms that the hashed file is changed or unchanged. In particular embodiments, the hash function utilizes a SSHA256 standard. In some embodiments, key consumption by degree assess that the adjustments to a modified resource were minor (e.g., cosmetic changes) to confirm that the subject matter does not need to be reverified, and that the student has consumed all course data. While the determination of key consumption is, in some cases, binary, additional techniques to improve the accuracy of the assessment are provided herein to develop deeper insights into the student's engagement with the materials.

In some embodiments, the content validation operations further comprise: applying a keyword analysis algorithm to each educational resource to generate an array of content validation keywords for the educational resource, and persisting each key in association with its respective educational resource and array of content validation keywords. In further embodiments, the array of content validation keywords comprises a frequency for each keyword. In some embodiments, the keyword analysis algorithm utilizes one or more neural networks. In some embodiments, the keyword analysis algorithm utilizes one or more regular expression methodologies. In some embodiments, the consumption validation operations further comprise: applying the keyword analysis algorithm to each educational resource to generate an array of content consumption keywords; and further determining the confidence level by comparing the array of content validation keywords to the array of content consumption keywords. In further embodiments, the confidence level is further determined by comparing a frequency of each content validation keyword to a frequency of each content consumption keyword. In some embodiments, the confidence score is generated using the Sorensen-Dice coefficient of similarity to calculate confidence for text.

In some embodiments, key consumption by degree employs key word identification by one or more of the following techniques:
using a neural network or regular expression to determine a percentage of key words that remain within a longer html text (e.g., a quiz);
store the key word list on the AMS;
generating a simple secret key to provide a unique identifier for where the content will be present (e.g., quiz);
storing the secret key in the metadata on the remote LMS;
generating a confidence score based on percentage of keywords present; and
comparing speaker attribution in video transcript or detected spoken word to list of students marked as present in synchronous meeting.

In some embodiments, multiple keys are applied to a learning resource to determine which parts of the learning resource was performed by the student (e.g., individual quiz questions) and to determine the type of learning resource (e.g., instructions text, video, or a downloadable file). In some embodiments, the determined learning resources consumed by a student is compared to other students in the same cohort to identify outliers. In one example, if a student has an acceptable confidence score but it is far exceeding his or her peers, a flag may be triggered for review. In some embodiments, the confidence score includes screenshots for further confidence score validation.

In some embodiments, the methods, systems, and media herein require a student to provide a new facial screenshot as a condition of secret key consumption. In some embodiments, the facial screenshot can be compared to an ID verification to demonstrate that attribution of consumption is correct.

In some embodiments, when a student consumes the key of a valid resources in the resource library of a course, and the consumption of resources is above the confidence threshold, then the learning event is attributed to the student's record in the record-keeping system. In some embodiments, when a student has consumed enough resources to meet the completion criteria in the resource library, and the consumption of resources is above the confidence threshold, then the student is eligible to complete the course.

Referring to FIG. 9B, in some embodiments, the platforms and systems comprise, and the methods utilize, an AMS 910 including an AMS server 920. In this embodiment, the AMS server 920 includes: a content ingestion module 925 configured to ingest a plurality of educational resources from a remote learning management system (LMS); a content validation module 930 configure to perform content validation operations comprising: applying a cryptographic hash function to each educational resource to generate a content validation hash; generating a unique key for each educational resource; persisting each key in association with its respective educational resource and content validation hash; and sending the keys and associations to the remote LMS; a student data streaming module 935 configured to receive a data stream from a computing device of a student user engaged with the educational resources on the remote LMS; a content consumption validation module 940 configured to perform consumption validation operations comprising extracting keys from the data stream; and a consumption confidence scoring module 945 configured to apply an algorithm 950 to generate a confidence level for the consumption validation of the extracted educational resources by performing confidence operations comprising: applying the cryptographic hash function to each educational resource to generate a content consumption hash; and determining a confidence level, at least in part, by comparing the content validation hash to the content consumption hash.

Continuing to refer to FIG. 9B, in this embodiment, the AMS server 920 optionally includes a keyword analysis module 955 configured to apply a keyword analysis algorithm to each educational resource to generate an array of content validation keywords for the educational resource, and persist each key in association with its respective educational resource and array of content validation keywords. In some cases, the keyword analysis module 955 and/or the keyword analysis algorithm is further configured to generate a frequency for each keyword. In various embodiments, the keyword analysis module 955 and/or the keyword analysis algorithm utilizes one or more neural networks and/or one or more regular expression methodologies. In such embodiments, the consumption validation operations further comprise: applying the keyword analysis algorithm to each educational resource to generate an array of content consumption keyword; and further determining the confidence level by comparing the array of content validation keywords to the array of content consumption keywords. And, in some cases, the confidence level is further determined by comparing a frequency of each content validation keyword to a frequency of each content consumption keyword.

Continuing to refer to FIG. 9B, in this embodiment, the AMS server 920 optionally includes a transcript/attendance analysis module 960 configured to extract an attendance list from the data stream; extract a transcript with speaker attributions from the data stream; and compare the extracted data to identify attending students. In such embodiments, the confidence operations further comprise further determining the confidence level by comparing the attendance list to the speaker attributions. In some embodiments, the confidence operations further comprise further determining the confidence level by comparing confidence levels for other students in a student group.

Continuing to refer to FIG. 9B, in this embodiment, the AMS server 920 optionally includes an image analysis module 965 configured to extract a screen recording or one or more screen shots from the data stream. In such embodiments, the confidence operations further comprise applying one or more facial detection and identification methodologies to the screen recording or screen shot. In further embodiments, the confidence operations further comprise further determining the confidence level by comparing an identified face to a known student photo.

The Student may receive grades for their engagement with resources. The grades may be weighted according to the courses' grade weight. In one example, quizzes might have a 30% graded weight and a final assignment has a 70% graded weight. The total number of quizzes required of students in course may be unknown when they enroll.

In some embodiments, the methods, systems, and media herein require a student to receive a minimum number of grades as they consume the resources in any order, regardless of a number of each type of resource. In some embodiments, the consideration of the average score if the student were to end the course without completing all of the minimum number of graded assignments and therefore receiving a score of 0 for those missing assignments (the predicted average), and the score a student receives upon completion of the minimum number of graded assignments but potentially many more than the minimum (the Final Average). The formulas for calculating these scores are as follows:
Predicted average counts only received weights, and the average score per weight denominator equals the number of received scores:

$$P = \backslash frac \{ \backslash sum\_ \{ i = 1 \} ⋀ \{ w \} \{ ( \backslash frac \{ 1 \} \{ s \} \backslash sum\_ \{ j = 1 \} ⋀ \{ s \} S\_ \{ j \} ) \backslash timesW\_i \} \} \{ \backslash sum\_ \{ i = 1 \} ⋀ \{ w \} \{ W\_i \} \}$$

Final average counts all required weights, and the average score per weight denominator equals either the number of received scores or the required number of scores to receive, whatever is bigger:

$$F = ∖ frac \{ ∖ sum\_ \{ i = 1 \} ⋀ \{ w \} \{ ( \backslash frac \{ 1 \} \{ s \} ∖ sum\_ \{ j = 1 \} ⋀ \{ s \} S\_ \{ j \} ) ∖ timesW\_i \} \} \{ \backslash sum\_ \{ i = 1 \} ⋀ \{ w \} \{ W\_i \} \}$$

### Wherein

$$G = \frac{( 1 / 3 ( {S}_{A 1} + {S}_{A 2} + {S}_{A 3} ) \times {W}_{A} ) + ( {S}_{B 1} \times {W}_{B} ) + ( 1 / 2 ( {S}_{C 1} + {S}_{C 2} ) \times {W}_{C} )}{{W}_{A} + {W}_{B} + {W}_{C}}$$

In some embodiments, course and/or degree completion can occur automatically by or a governance flow, regardless of the order in which the classes were taken. In some embodiments, when a student is approved as completing a course, the final average is added to the student's transcript and the local record-keeping system stops recording the student's activity for the course. In some embodiments, once a student completes a minimum number of courses in a degree, per the degree profile, and receives a minimum number of final average grades for those courses. In some embodiments, when the student is approved as completed for a degree, the average of all final averages in the degree's courses are added to the student's transcript, and the local record-keeping system stops recording the student's activity for the degree, whereafter a digital degree certificate is automatically issued to the student.

### Method for Demonstrating Fulfillment of Requirements by a Student on a Local LMS

The methods, systems, and media herein are configured to validate the learning activities of a student on a local LMS while integrating with a record-keeping system to demonstrate that the student fulfills all of the requirements located on the record-keeping system. In some embodiments, a local LMS is used which is identical to the remote LMS. In some embodiments, there is no requirement to install an SDK or have users authorized in two systems, because all events occur within a locally controlled system.

Local LMS usage can be used for further control of the resource consumption pattern because course resources can be organized into cohorts, which consist of a sequence of lessons containing at least the minimum number of resources required to be eligible to complete a degree. In some embodiments, the cohort sets a learning pathway that must be fulfilled before a student is eligible for course completion, with or without confirmation that HQA and SQA standards are applied. In some embodiments, the cohort profile parameters match the valid license parameters for the course profile, wherein the sum total of credits/workload in the cohort lessons match the sum total of the credits/workload requirements of the course. In some embodiments, the verified education level of all staff admissible to the cohort matches the course license requirements and the verified education level for admissible students matches the course license requirements.

In some embodiments, a cohort that meets all minimum requirements can be approved automatically or by a Governance Workflow. In one example, a cohort approval committee is the Academic Board of the College, comprising at least two College members with verified identities and verified PhDs. In some embodiments, a number of cohorts per permit is controlled structuring of resource consumption. In some embodiments, a lesson can be locked until prior lessons are completed. In some embodiments, lessons can enforce distribution of resource consumption with the credits/workload apportioned, or have required resource kinds allocated (e.g., assignments or meetings) with no lesson less than N or greater than N Credits/Workload or Resources. In some embodiments, the sum of credits/workload of all lessons must fulfill the sum required of the cohort which must fulfill the sum required by the course.

In some embodiments, SQA standards are inherited by the cohort from the course if the cohort has:
a set number of PhDs;
a set number of master's degrees;
a set number of each kind of resource;
a set number of students enrolled in the last X months;
a set staff survey score;
a set student survey score;
a set number of weekly active staff;
a set number of weekly active students;
the resources that meet all of the course profile HQA requirements;
staff that meet all of the course profile HQA requirements; or
any combination thereof.

### Transferring and Swapping Credits

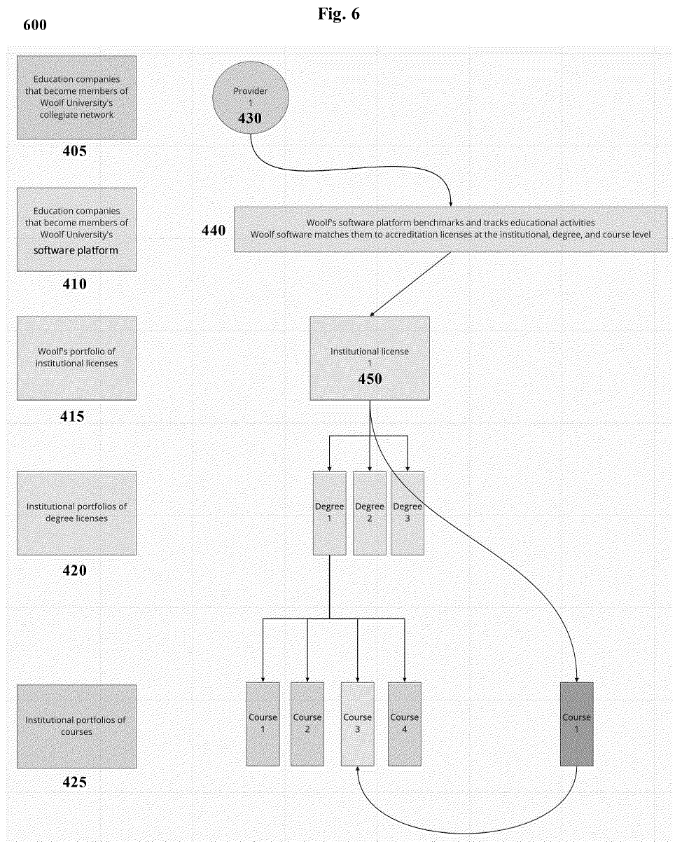

FIG. 6 shows a non-limiting example of a schematic process diagram for substituting one course for another course in order to fulfill a degree license requirement. As shown, substituting one course 570 for another course 570 to fulfill a degree license requirement 560 allows for the rapid creation of novel accredited programs.

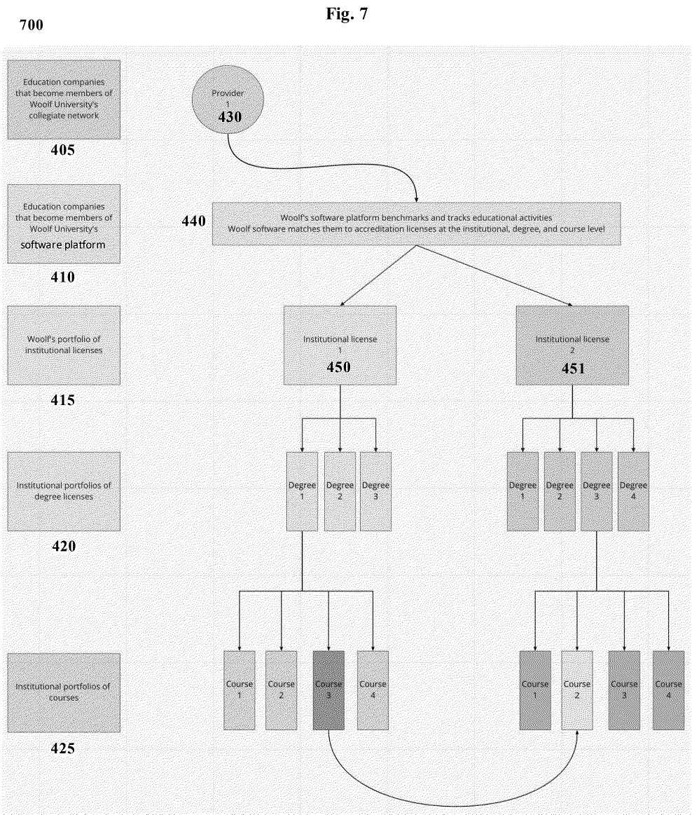

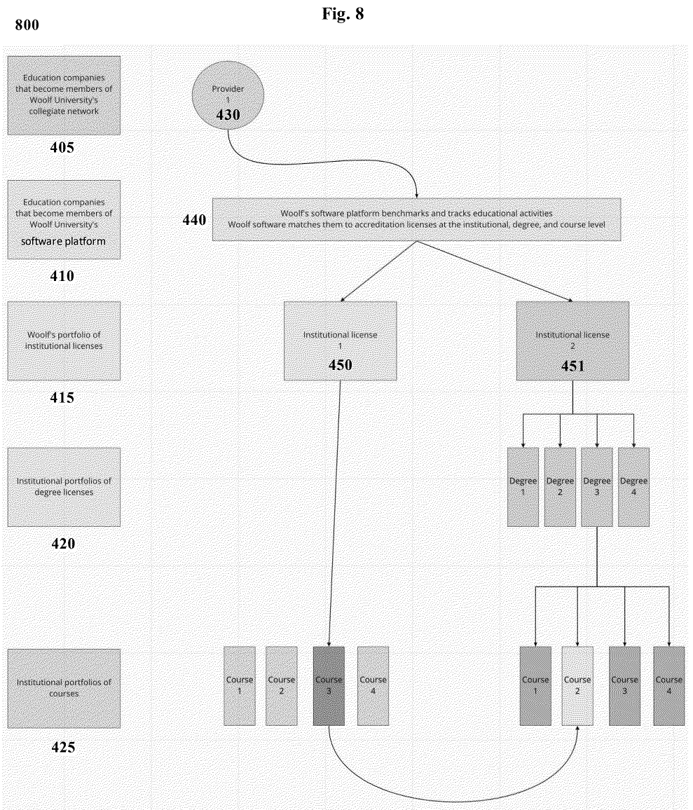

FIGS. 7 and 8 shows examples of a schematic process diagram of processes for transferring course credits from one institutional license to another institutional license to fulfill degree requirements under the second institutional license and degree license. As shown, substituting one course 570 at a first institutional license 450 for another course 570 at a second institutional license to fulfill a degree license requirement 560 allows for the rapid creation of novel accredited programs.

### Alternative Embodiment—Study Track for the Web

In some embodiments, the systems, methods, and media described herein provide an accreditation management system (AMS). In further embodiments, the AMS provides data integrity, at least in part, by performing content validation operations. In still further embodiments, a LMS sends content to the systems, methods, and media described herein, which then: 1) benchmarks that content; 2) creates a hash key for the content; and 3) sends that key back to the LMS. Subsequently, when a learner consumes the content, the subject matter described herein 4) monitors the learner's browser stream for the key. Once the key is found, the subject matter described herein: 5) performs a hash key test to prove that the consumed content is the benchmarked content, without substantial modification, and 6) finally, attributes credit for the consumed content to the learner. In some embodiments, this methodology is performed for learners who are enrolled in a degree program.

However, in other embodiments, the methodology does not include generating keys or sending keys to the LMS. In such embodiments, data from a learner's computer, particularly a learner's web browser, is streamed to the AMS described herein. This data stream is parsed to identify the educational resources consumed by the learner (without keys) and validate the content by applying an algorithm to compare the content to that previously encountered by the AMS (without the unique keys). In these alternative embodiments, the first time the AMS encounters the content, it is evaluated against educational benchmarks, and the second time the AMS encounters the content (which can be concurrent with the first time), it is compared to the benchmarked content to determine if the ingested content is the benchmarked content, without substantial modification (which may include using a hash test), and if academic credit can be attributed. Such alternative embodiments differ in two primary regards. First, the educational content is not provided by the LMS ahead of time, via an API, instead the content is streamed in from a learner's browser as they consume it, even in the first time it is encountered. Second, the entire evaluation of the content is performed every time it is encountered and once it has been determined that its been seen before, the matching comparison is done without the key step.

### Exemplary Use Case—Study Track

In some embodiments, the systems, methods, and media described herein are used to provide data integrity regardless of enrollment status of learners. For example, one problem, addressed by the subject matter described herein, is creating records that meet requirements arising in situations where a learner attempts to have their learning record validated with regard to work that was performed prior to formal enrollment in the degree program for which the learner is seeking recognition (often called “recognition of prior learning”). In such cases, the systems, methods, and media described herein provide data integrity for recognition of prior learning.

In some embodiments, a LMS sends content to the systems, methods, and media described herein, which then: 1) benchmarks that content; 2) creates a hash key for the content; and 3) sends that key back to the LMS. Subsequently, when a learner consumes the content, the subject matter described herein 4) monitors the learner's browser stream for the key. Once the key is found, the subject matter described herein: 5) performs a hash key test to prove that the consumed content is the benchmarked content, without substantial modification, and 6) finally, attributes credit for the consumed content to the learner. In some embodiments, this methodology is performed for learners who are enrolled in a degree program.

However, in other embodiments, the same methodology is utilized for learners who are not enrolled in a degree program, but completing coursework. In such embodiments, the resulting log of the learner's activity has sufficient data integrity to allow the activity to later be converted to academic credit in a degree program. In further embodiments, the student is informed that their activity could be converted to a particular amount of credit in a degree program, if they were to enroll such a program or the student is informed that their activity could constitute a particular percentage of completion of a degree program, if they were to enroll such a program.

### Exemplary Use Case—Study Track Convert

In some embodiments, the systems, methods, and media described herein are used to predict a likelihood of a particular learner successfully converting coursework completed to a degree program. In some embodiments, the prediction is made by utilizing a prediction engine. In still further embodiments, the prediction is at least in part based on content consumption by the learner and data enrichment specific to the learner. Content consumption suitably includes, by way of non-limiting examples, type of content consumed, amount of content consumed, quality of consumption, channel of consumption, performance in assessments associated with the content, results of surveys associated with the content. Data enrichment suitably includes, by way of non-limiting examples, age and/or generation group, sex, gender, and/or sexual orientation, nationality, race and/or ethnicity, current educational level, employment status and/or occupation, personal and/or household income, marital status, number of children, homeownership (own or rent), place of residence, state, address and/or zip code, health and/or disability status, political affiliation or preference, religious affiliation or preference, or any combination thereof. In other embodiments, the systems, methods, and media described herein are used to predict a likelihood of a particular group of learners successfully converting coursework completed to a degree program.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

1. A computer-implemented system comprising a computing device comprising at least one processor and instructions executable by the at least one processor to provide an accreditation management system (AMS) comprising:
a) a software module configured to ingest a plurality of educational resources;
b) a software module configured to validate the ingested educational resources by performing content validation operations comprising:
i) applying a cryptographic hash function to each educational resource to generate a content validation hash;
ii) generating a unique key for each educational resource;
iii) persisting each key in association with its respective educational resource and content validation hash; and
iv) sending the keys and associations to a remote learning management system (LMS);
c) a software module configured to receive a data stream from a computing device of a student user engaged with the educational resources on the remote LMS;
d) a software module configured to validate consumption of the educational resources by the student user by performing consumption validation operations comprising extracting keys from the data stream; and
e) a software module configured to apply an algorithm to generate a confidence level for the consumption validation of the extracted educational resources by performing confidence operations comprising:
i) applying the cryptographic hash function to each educational resource to generate a content consumption hash; and
ii) determining a confidence level, at least in part, by comparing the content validation hash to the content consumption hash.

2. The system of claim 1, wherein the content validation operations further comprise classifying the educational resources.

3. The system of claim 1, wherein the content validation operations further comprise applying a rules-based governance workflow to approve each educational resource.

4. The system of claim 3, wherein the educational resources are organized into a cohort, and wherein the content validation operations further comprise applying a rules-based governance workflow to approve the cohort.

5. The system of claim 1, wherein each key is associated with its respective educational resource as metadata to the educational resource.

6. The system of claim 1, wherein the cryptographic hash function utilizes a SSHA256 standard.

7. The system of claim 1, wherein the data stream from the computing device of the student user is generated by a browser widget, add-in, add-on, or extension.

8. The system of claim 7, wherein the data stream from the computing device of the student user is generated by a visible browser widget.

9. The system of claim 7, wherein the data stream from the computing device of the student user is generated by an invisible browser widget.

10. The system of claim 1, wherein the content validation operations further comprise:
a) applying a keyword analysis algorithm to each educational resource to generate an array of content validation keywords for the educational resource, and
b) persisting each key in association with its respective educational resource and array of content validation keywords.

11. The system of claim 10, wherein the array of content validation keywords comprises a frequency for each keyword.

12. The system of claim 10, wherein the keyword analysis algorithm utilizes one or more neural networks.

13. The system of claim 10, wherein the keyword analysis algorithm utilizes one or more regular expression methodologies.

14. The system of claim 10, wherein the consumption validation operations further comprise:
a) applying the keyword analysis algorithm to each educational resource to generate an array of content consumption keywords; and
b) further determining the confidence level by comparing the array of content validation keywords to the array of content consumption keywords.

15. The system of claim 14, wherein the confidence level is further determined by comparing a frequency of each content validation keyword to a frequency of each content consumption keyword.

16. The system of claim 1, wherein the consumption validation operations further comprise:
a) extracting an attendance list from the data stream; and
b) extracting a transcript with speaker attributions from the data stream.

17. The system of claim 16, wherein the confidence operations further comprise further determining the confidence level by comparing the attendance list to the speaker attributions.

18. The system of claim 1, wherein the confidence operations further comprise further determining the confidence level by comparing confidence levels for other students in a student group.

19. The system of claim 1, wherein the consumption validation operations further comprise extracting a screen recording or screen shot from the data stream.

20. The system of claim 19, wherein the confidence operations further comprise applying one or more facial detection and identification methodologies to the screen recording or screen shot.

21. The system of claim 20, wherein the confidence operations further comprise further determining the confidence level by comparing an identified face to a known student photo.

22. The system of claim 1, wherein each educational resource comprises one or more defined intended learning outcomes (ILOs), at least one workload, and at least one grade weight.

23. (canceled)

24. A method comprising:
a) ingesting, at an accreditation management system (AMS), a plurality of educational resources;
b) validating, at the AMS, the ingested educational resources by performing content validation operations comprising:
i) applying a cryptographic hash function to each educational resource to generate a content validation hash;
ii) generating a unique key for each educational resource;
iii) persisting each key in association with its respective educational resource and content validation hash; and
iv) sending the keys and associations to a remote learning management system (LMS);
c) receiving, at the AMS, a data stream from a computing device of a student user engaged with the educational resources on the remote LMS;
d) validating, at the AMS, consumption of the educational resources by the student user by performing consumption validation operations comprising extracting keys from the data stream; and
e) applying, at the AMS, an algorithm to generate a confidence level for the consumption validation of the extracted educational resources by performing confidence operations comprising:
i) applying the cryptographic hash function to each educational resource to generate a content consumption hash; and
ii) determining a confidence level, at least in part, by comparing the content validation hash to the content consumption hash.

25-49. (canceled)

50. Non-transitory computer-readable storage media encoded with instructions executable by one or more processors to create an education accreditation management application comprising:
a) a database comprising education records;
b) a content ingestion module ingesting a plurality of educational resources;
c) a content validation module performing content validation operations comprising:
i) applying a cryptographic hash function to each educational resource to generate a content validation hash;
ii) generating a unique key for each educational resource;
iii) persisting each key in association with its respective educational resource and content validation hash; and
iv) sending the keys and associations to a remote learning management system (LMS);
d) a streaming module receiving a data stream from a computing device of a student user engaged with the educational resources on the remote LMS;
e) a content consumption validation module performing consumption validation operations comprising extracting keys from the data stream; and
f) a consumption confidence scoring module applying an algorithm to generate a confidence level for the consumption validation of the extracted educational resources by performing confidence operations comprising:
i) applying the cryptographic hash function to each educational resource to generate a content consumption hash; and
ii) determining a confidence level, at least in part, by comparing the content validation hash to the content consumption hash.

51-97. (canceled)
